(19) United States
(12) Patent Application Publication
(10) Pub. No.: US 2014/0041283 A1
(43) Pub. Date: Feb. 13, 2014

(54) Fishing Lure Apparatus and Method

(71) Applicant: Loren Dunbar, Zillah, WA (US)

(72) Inventor: Loren Dunbar, Zillah, WA (US)

(21) Appl. No.: 13/605,975

(22) Filed: Sep. 6, 2012

Related U.S. Application Data
(60) Provisional application No. 61/681,102, filed on Aug. 8, 2012.

(51) Int. Cl. A01K 85/00; A01K 99/00

(52) U.S. Cl. 43/42.53; 43/42

(57) ABSTRACT

A custom fishing lure and a method for making a custom fishing lure. The fishing lure generally comprises one or more beads threaded on an elastic band. The elastic band secures the bead to a fishing line and, in an embodiment, secures hackle and other components to the fishing lure. The method of the invention generally comprises stretching an elastic band, threading the stretched elastic band and a length of fishing line through the aperture of a bead, and then releasing the tension on the elastic band. In an additional embodiment, the method includes the additional steps of securing the ends of the elastic band so as to hold the elastic band in a stretched condition, threading hackle or other components partially through the bead aperture, and then releasing the ends of the elastic band to secure the hackle or other component on the fishing lure. This method allows the angler to quickly and easily create an unlimited variety of lures to imitate insects, fish, crustaceans, and bugs for all fishing environments.

### CROSS-REFERENCE TO RELATED APPLICATIONS

This application claims priority of U.S. Provisional Application Ser. No. 61/681,102 filed Aug. 8, 2012.

### STATEMENT REGARDING FEDERALLY SPONSORED RESEARCH OR DEVELOPMENT

None

### BACKGROUND AND SUMMARY OF THE INVENTION

Anglers use a wide assortment of materials, shapes and colors of lures to attract fish. Making custom lures is meticulous, challenging and time consuming. A need exists for a fishing lure that can be made by an angler quickly and easily using a variety of materials. In particular, a need exists for a fishing lure apparatus and method that allows for the quick, easy and secure assembly of beads and other components in a fishing lure, which can be secured to a fishing line easily and with no damage to the line.

The invention described herein is a custom fishing lure, and a method for making a custom fishing lure. The fishing lure generally comprises one or more beads threaded on an elastic band. The elastic band secures the bead to a fishing line and, in an embodiment, secures hackle and other components to the fishing lure. The method of the invention generally comprises stretching an elastic band, threading the stretched elastic band and a length of fishing line through the aperture of a bead, and then releasing the tension on the elastic band. In an additional embodiment, the method includes the additional steps of securing the ends of the elastic band so as to hold the elastic band in a stretched condition, threading hackle or other components partially through the bead aperture, and then releasing the ends of the elastic band to secure the hackle or other component on the fishing lure. In an alternative embodiment, a loop is formed in the elastic band for receiving and securing a length of fishing line that does not pass through the bead aperture. A clamping system may be used to hold the stretched elastic band and beads in position while the additional components are added. When the tension on the elastic band is released, the elastic band expands within the beads. This system allows the angler to create lures to imitate insects, fish, crustaceans, and bugs for all fishing environments. Possible combinations are limited only by the angler's imagination.

### BRIEF DESCRIPTION OF THE ILLUSTRATIONS

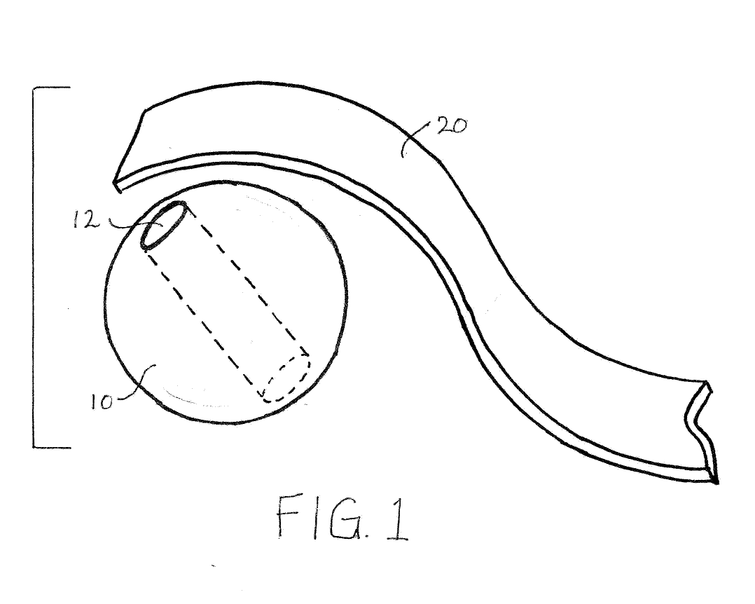

FIG. 1 shows the bead and elastic band that comprise the invention;

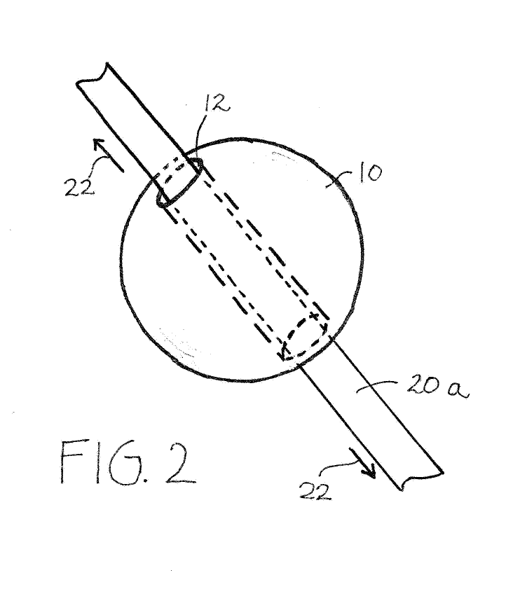

FIG. 2 is a perspective view of an embodiment of the fishing lure of the present invention, in a partially assembled state;

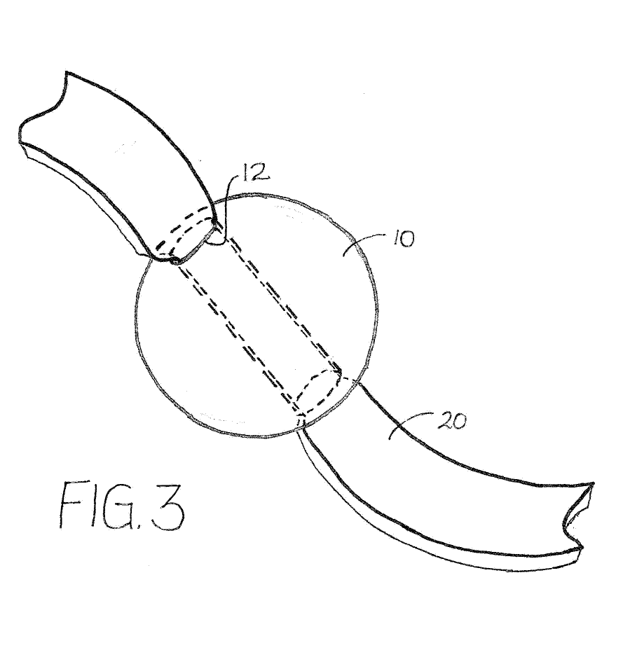

FIG. 3 is a perspective view of an embodiment of the fishing lure of the present invention;

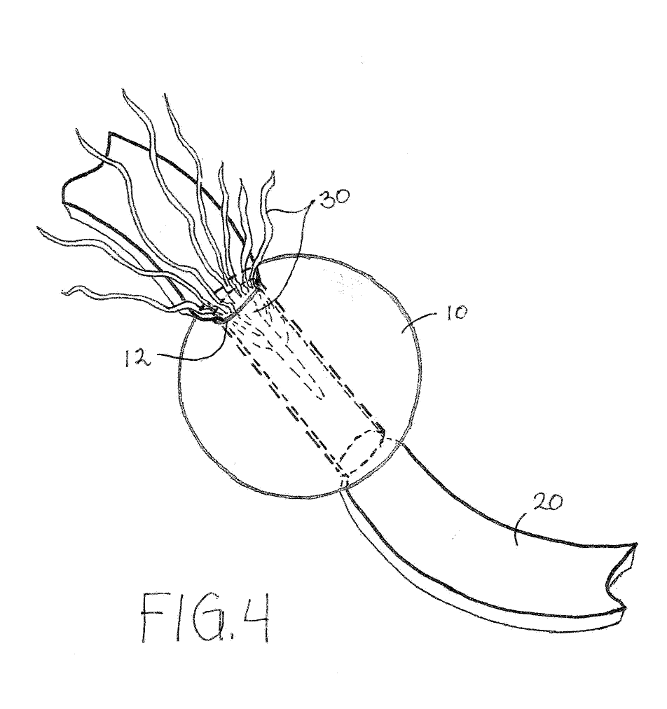

FIG. 4 is a perspective view of an embodiment of the fishing lure of the present invention; and

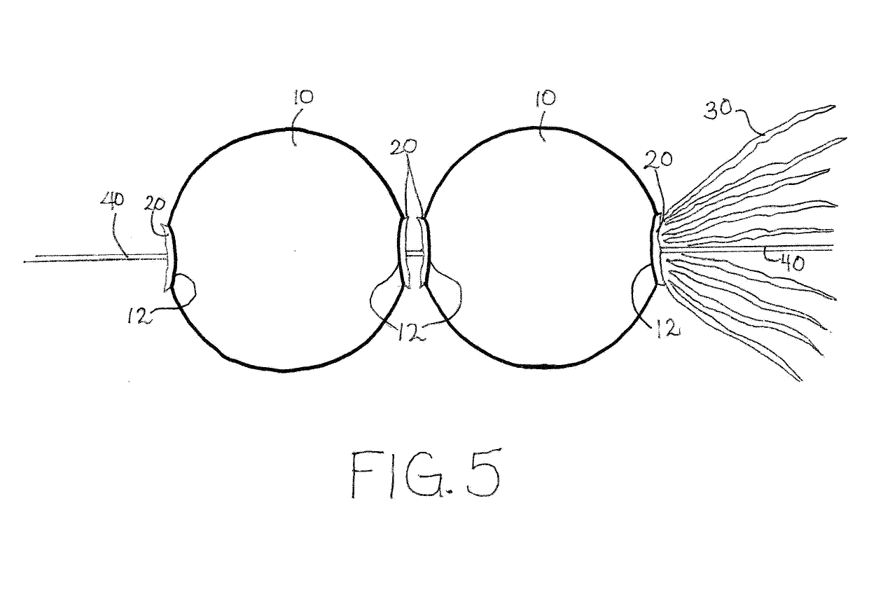

FIG. 5 is side view of an embodiment of the fishing lure of the present invention.

### DETAILED DESCRIPTION

The fishing lure of the present invention comprises at least one bead 10 and a length of elastic band 20, as shown in the attached drawings. The bead may be glass, plastic, wood, foam, or any other suitable material. FIG. 1 shows the bead 10 having an aperture 12 running through the body of the bead, such that a fishing line, hackle, fish hook shank or hook tool can be threaded through the bead. The elastic band 20 is preferably an elastomer or rubber material. In its relaxed (unstretched) condition, the elastic band is wider than the bead aperture, as shown in FIG. 1, and cannot be threaded through the bead. When stretched, the elastic band is lengthened and is narrowed sufficiently to be threaded through the bead aperture. Once stretched and then released, the elastic band returns to its previous relaxed condition and size.

According to the invention, the elastic band 20 is stretched, as indicated by arrows 22, to form a narrowed stretched elastic band 20a as shown in FIG. 2. In an alternative embodiment, the elastic band band may be folded in half or more, to form multiple thicknesses, or more than one elastic band may be used. The narrowed stretched elastic band is threaded through the bead 10. Once the tension is released, the narrowed stretched elastic band returns to its relaxed state 20, as shown in FIG. 3. Because the relaxed elastic band is thicker than the stretched and narrowed elastic band, it fills the free space in the bead aperture 12 and holds the bead in place. The bead does not easily slide on the relaxed elastic band, but it can be repositioned on the elastic band by first stretching the elastic band and then moving the bead. Alternatively, the bead may be repositioned by applying force to the bead.

In an embodiment, the fishing lure of the present invention further comprises a feather, yarn, hackle, or any other element that is used to attract fish to the lure, for simplicity referred to collectively herein and in the appended claims as hackle. The hackle 30, shown in FIGS. 4 and 5, is secured to the lure by stretching the elastic band 20, inserting a portion of the hackle in the aperture 12, and releasing the tension on the elastic band.

In an embodiment, the fishing lure of the present invention further comprises a length of fishing line 40 threaded through the bead aperture 12, as shown in FIG. 5.

In an embodiment, the fishing lure of the present invention further comprises a fish hook (not shown). The fish hook is secured to the lure by stretching the elastic band 20, inserting a portion of the shank of the fish hook in the aperture 12, and releasing the tension on the elastic band.

It is to be understood that the fishing lure may have one, two or several beads. The elastic band may be of a single thickness, or may be doubled to form a loop at one end. The fishing lure may be made without hackle, or with one, two or more pieces of hackle of the same or different materials. The fishing line and the hook may be included or not, according to the angler's preference. It is expected, and in fact an important object of the invention, that the angler will mix and match the elements described herein to achieve the desired custom fishing lure.

The invention includes a method for making a fishing lure. For simplicity, the method described herein refers to each of the elements in the singular, and does not describe every possible combination of components. However, the use of the method described herein to achieve a wide variety of combinations is understood to be within the scope of the invention.

According to an embodiment of the method of the invention, a bead 10 having an aperture 12 is selected. A length of fishing line 40 is threaded through the bead aperture.

Next, a length of elastic band 20, as described above, is selected. A small hook tool, preferably a latch hook tool, is inserted through the aperture 12 in the bead 10 so that the hook is clear of the bead. The elastic band is then looped and secured on the hook, and the elastic band is stretched. Using the hook tool and keeping the tension on the elastic band, the elastic band loop is pulled through the aperture in the bead aperture. Once the elastic band is pulled through, the tension can be released. The elastic band returns to its relaxed configuration and fills the bead aperture. The bead is now secure on the elastic band and the fishing line.

According to this embodiment, the elastic band 20 is pulled through the bead aperture 12 so that the loop is eliminated and a single thickness of elastic band remains in the bead aperture. If the user elects to add hackle 30, a hook, or other elements to the lure, they may be added at this point. This is accomplished by stretching the elastic band and securing each end of the elastic band to hold the fishing lure (now comprising a bead, an elastic band, and fishing line) in a generally horizontal position for the next steps. The object of stretching the elastic band and securing the ends is to hold the elastic band in its stretched and narrowed condition, to allow the free side-to- side movement of the bead on the elastic band, and to allow space for insertion of the hook tool through the bead aperture. A vise having two clamps located approximately 3 inches to 6 inches apart is useful for holding the ends of the elastic band. Preferably, the vise includes a magnifying glass to aid in the construction of the fishing lure.

Next, the hackle 30 is selected. The hook tool is then inserted through the bead aperture 12, and the hackle is hooked and pulled back into the aperture 12 to the desired position.

Finally, the tension on the elastic band 20 is released. The elastic band returns to its relaxed condition and size, thus filling the bead aperture 12. The elastic band now securely engages the bead 10, the fishing line 40, the hackle 30, and any additional components. Although some movement is still possible, which is useful in allowing the angler to slide the lure assembly up and down the fishing line to a desired position, the movement is limited, and the additional components are unlikely to be pulled loose.

In an additional embodiment of the method of the present invention, the fishing line 40 is omitted from the fishing lure assembly process. The fishing lure constructed according to this embodiment is particularly useful when the angler wishes to make lures that can be neatly and easily stored in a tackle box and are ready to be attached quickly, easily and securely to an existing fishing line. In this embodiment, the elastic band 20 is pulled through the bead aperture 12 as described above, but is left in its looped configuration, so that a loop extends out of the bead aperture at one end, two thickness of elastic band remain in the bead aperture, and the two ends of the elastic band extend from the aperture opening opposite the elastic band loop. In use, this fishing lure is attached to a fishing line by threading the fishing line through the elastic band loop, and pulling on the ends of the elastic band to retract the loop into the bead aperture. The ends can then be trimmed close to the bead 10. The fishing lure is now secure on the fishing line without the need for tying or otherwise weakening the fishing line.

In compliance with the statutes, the invention has been described in language more or less specific as to structural features and process steps. While this invention is susceptible to embodiment in different forms, the specification illustrates preferred embodiments of the invention with the understanding that the present disclosure is to be considered an exemplification of the principles of the invention, and the disclosure is not intended to limit the invention to the particular embodiments described. Those with ordinary skill in the art will appreciate that other embodiments and variations of the invention are possible, which employ the same inventive concepts as described above. Therefore, the invention is not to be limited except by the following claims, as appropriately interpreted in accordance with the doctrine of equivalents.

I claim:

1. A fishing lure comprising:
A bead having an aperture therethrough;
An elastic band received within the bead aperture, the elastic band having a relaxed width and a stretched width, wherein the relaxed width is wider than the bead aperture, and the stretched width is sufficiently narrow to be received within the bead aperture; and
Wherein the elastic band substantially fills the free space in the bead aperture.

2. The fishing lure of claim 1, further comprising:
A fishing line received within the bead aperture;

3. The fishing lure of claim 1, further comprising:
Hackle, wherein a portion of the hackle is received in the bead aperture and is held in place by the elastic band.

4. A fishing lure comprising:
A bead having an aperture therethrough;
An elastic band received within the bead aperture, the elastic band having a relaxed width and a stretched width, wherein the relaxed width is wider than the bead aperture, and the stretched width is sufficiently narrow to be received within the bead aperture;
Wherein a loop is formed in the elastic band, and said loop protrudes from the bead aperture; and,
Wherein the elastic band substantially fills the free space in the bead aperture.

5. A method for making a fishing lure, the method comprising the steps of:
Selecting a bead having an aperture therethrough;
Selecting an elastic band having a relaxed width and a stretched width, wherein the relaxed width is wider than the bead aperture, and the stretched width is sufficiently narrow to be received within the bead aperture;
Stretching the elastic band;
Threading the stretched elastic band through the bead aperture; and
Releasing the elastic band.

6. The method of claim 5, wherein the step of threading the elastic band is carried out by:
Forming a loop in the elastic band;
Inserting a hook tool through the bead aperture;
Using the hook tool to grasp the loop in the elastic band;
Pulling the elastic band through the bead aperture with the hook.

7. The method of claim 5, further comprising the steps of:
Stretching the elastic band;
Holding the elastic band in the stretched position by securing the ends of the elastic band;
Inserting hackle in the bead aperture; and
Releasing the elastic band.

8. The method of claim 5, further comprising the step of:
Threading a fishing line through the bead aperture.
